(19) United States
(12) Patent Application Publication
(10) Pub. No.: US 2023/0259583 A1
(43) Pub. Date: Aug. 17, 2023

(54) METHOD AND PROCESSING UNIT FOR GENERATING AN OUPUT FEATURE MAP

(71) Applicant: Arm Limited, Cambridge (GB)

(72) Inventor: Fredrik Peter STOLT, Cambridge (GB)

(21) Appl. No.: 18/167,537

(22) Filed: Feb. 10, 2023

(30) Foreign Application Priority Data
Feb. 15, 2022 (GB) 2202001.0

(51) Int. Cl. G06F 17/16; G06F 7/544

(52) U.S. Cl. CPC G06F 17/16; G06F 7/5443

(57) ABSTRACT

A method performed by a processing unit for generating an output feature map, the processing unit comprising an input feature map storage configured to store input feature map blocks. The input feature map storage is read by the processing unit to generate output feature map blocks. The method comprises sequentially loading input feature map blocks into the input feature map storage, using a first input feature map block stored in the input feature map storage to generate a partial computation for a first output feature map block, and reusing the first input feature map block stored in the input feature map storage to generate a partial computation for a second output feature map block without reloading the first input feature map block into the input feature map storage.

### CROSS-REFERENCE TO RELATED APPLICATION

This application claims the benefit under 35 U.S.C. § 119(a) and 37 CFR § 1.55 to United Kingdom Patent Application No. 2202001.0, filed on Feb. 15, 2022, which application is incorporated herein by reference in its entirety.

### TECHNICAL FIELD

The present invention relates to a method and processing unit for generating an output feature map.

### BACKGROUND

Neural networks have emerged as powerful tools for image processing, inference, machine learning, and related tasks. Neural networks may include convolutional layers. In a convolutional layer, an output data array, referred to as an output feature map (OFM), is computed via convolutions between an input data array, referred to as an input feature map (IFM), and a matrix of weights.

The convolutional computations account for a significant portion of the computational cost of performing inference or training for a neural network, both in terms of processing time and in terms of the power required to switch bits within registers. Since these computations are performed repeatedly during inference or training, specialised integrated circuits called hardware accelerators have been developed.

A neural processing unit (NPU) is a hardware accelerator which is specialised for processing data in accordance with neural networks, for example, convolutional neural networks (CNNs). A NPU includes an array of specialised convolution engines (CEs), which each contain multiply-accumulate (MAC) hardware to perform convolutional operations.

It is desirable to improve the efficiency of NPUs to reduce the power consumption and heat generated by the NPU.

### SUMMARY

According to a first aspect there is provided a method performed by a processing unit for generating an output feature map, the processing unit comprising an input feature map storage configured to store input feature map blocks, the input feature map storage being readable by the processing unit to generate output feature map blocks, the method comprising: sequentially loading input feature map blocks into the input feature map storage, wherein the input feature map blocks stored in the input feature map storage at a given time during the sequential loading form a subset of a plurality of input feature map blocks that are required to generate each output feature map block, reading a first input feature map block stored in the input feature map storage during reading of a first sequence of input feature map blocks used to generate partial computations for a first output feature map block, and reading a second time the first input feature map block stored in the input feature map storage during reading of a second sequence of input feature map blocks used to generate partial computations for a second output feature map block, wherein the first sequence is different from the second sequence.

The first input feature map block may be a final input feature map block of the first sequence. The first input feature map block may be a first input feature map block of the second sequence. The first sequence may be a linear sequence of input feature map blocks in a first direction along a channel dimension of the input feature map. The second sequence may be the reverse of the first sequence.

The processing unit may transfer the input feature map blocks from the input feature map storage to dot product units. The dot product units may process the input feature map blocks for generating the output feature map blocks. The dot product units may compute a dot product of values from the input feature map blocks with weight data. The dot product units may generate partial computations and the partial computations may be sent to one or more accumulators. The accumulators may add the partial computations for generating accumulated values for the output feature map blocks. The processor may process the accumulated values to generate output feature map values for the output feature map blocks. Processing the accumulated values may comprise applying an activation function.

The input feature map blocks may each comprise at least one input feature map channel. The output feature map blocks may each comprise at least one output feature map channel. A weight storage may store a set of weights for use by the dot product units. The set of weights may comprise rows of weights. Each row of weights may correspond to an output feature map channel. Weight values in each row of weights may correspond to respective input feature map channels. The method may comprise generating a partial computation for an output feature map block by calculating, by the dot product units, for each output feature map channel, a dot product between a partial row of weights and an input feature map vector. The input feature map vector may comprise the input feature map elements of the given input feature map block associated with the partial row of weights in a machine learning model. Generating an output feature map block may comprise, for each output feature map channel of the given output feature map block, summing the dot products generated by processing the sequence of input feature map blocks for the output feature map channel.

The input feature map storage may be able to store a predetermined number of input feature map blocks. The method may comprise reusing the predetermined number of input feature map blocks without reloading the predetermined number of input feature map blocks into the input feature map storage to generate partial computations for the second output feature map block.

The input feature map storage may be controlled to operate as a first-in first-out buffer.

The processing unit may control an address pointer of the input feature map storage to control the sequence in which input feature map blocks are used to generate partial computations for the second output feature map block. The address pointer may be used to control reading of the input feature map blocks. The address pointer may be used to cause input feature maps blocks to be re-read from the input feature map storage thereby reusing the input feature map blocks.

The processing unit may control a read pointer and a release signal. The read pointer and the release signal may be used to release input feature map blocks such that the first input feature map block can be reused. The processing unit may control a write pointer to control writing of input feature map blocks to the input feature map storage. The read pointer, release signal and write pointer may be controlled to prevent writing over the first input feature map block in the input feature map storage until it has been reused to generate a partial computation for a second output feature map block.

Sequentially loading the input feature map blocks into the input feature map storage may comprise transferring the input feature map blocks from an external storage to the input feature map storage. The external storage may be external to the processing unit.

A second aspect may provide a processing unit configured to perform a method for generating an output feature map, the processing unit comprising an input feature map storage configured to store input feature map blocks, the input feature map storage being readable by the processing unit to generate output feature map blocks, the method comprising: sequentially loading input feature map blocks into the input feature map storage, wherein the input feature map blocks stored in the input feature map storage at a given time during the sequential loading form a subset of a plurality of input feature map blocks that are required to generate each output feature map block; reading a first input feature map block stored in the input feature map storage during reading of a first sequence of input feature map blocks used to generate partial computations for a first output feature map block; and reading a second time the first input feature map block stored in the input feature map storage during reading of a second sequence of input feature map blocks used to generate partial computations for a second output feature map block, wherein the first sequence is different from the second sequence.

A third aspect may provide a computer-readable medium storing instructions which, when executed by a processing unit, cause the processing unit to perform: a method performed by the processing unit for generating an output feature map, the processing unit comprising an input feature map storage configured to store input feature map blocks, the input feature map storage being readable by the processing unit to generate output feature map blocks, the method comprising: sequentially loading input feature map blocks into the input feature map storage, wherein the input feature map blocks stored in the input feature map storage at a given time during the sequential loading form a subset of a plurality of input feature map blocks that are required to generate each output feature map block; reading a first input feature map block stored in the input feature map storage during reading of a first sequence of input feature map blocks used to generate partial computations for a first output feature map block; and

reading a second time the first input feature map block stored in the input feature map storage during reading of a second sequence of input feature map blocks used to generate partial computations for a second output feature map block, wherein the first sequence is different from the second sequence.

Further features and advantages will become apparent from the following description of preferred embodiments, given by way of example only, which is made with reference to the accompanying drawings.

### BRIEF DESCRIPTION OF THE DRAWINGS

FIG. 1 is a schematic diagram showing an example of a multiply-accumulate operation performed during computation of an output feature map.

FIG. 2 is a schematic diagram of a neural processing unit.

FIG. 3 is a schematic diagram illustrating the relationship between an input feature map, weights and an output feature map.

FIGS. 4A and 4B depict steps of a method for computing an output feature map, which falls outside of the scope of the claims.

FIGS. 5A and 5B depict steps of a further method for computing an output feature map.

FIGS. 6A and 6B are schematic diagrams showing memory usage as plural input feature map blocks are written to and read from in an input feature map random access memory buffer.

FIG. 7 is a flow diagram showing a method performed by a processing unit.

### DETAILED DESCRIPTION

Details of systems and methods according to examples will become apparent from the following description with reference to the figures. In this description, for the purposes of explanation, numerous specific details of certain examples are set forth. Reference in the specification to ‘an example’ or similar language means that a feature, structure, or characteristic described in connection with the example is included in at least that one example but not necessarily in other examples. It should be further noted that certain examples are described schematically with certain features omitted and/or necessarily simplified for the ease of explanation and understanding of the concepts underlying the examples.

Certain examples described herein relate to a method performed by a processing unit for generating an output feature map. The processing unit comprises an input feature map storage configured to store input feature map blocks. The input feature map storage is readable by the processing unit to generate output feature map blocks. The method comprises: sequentially loading input feature map blocks into the input feature map storage, wherein the input feature map blocks stored in the input feature map storage at a given time during the sequential loading form a subset of a plurality of input feature map blocks that are required to generate each output feature map block, reading a first input feature map block stored in the input feature map storage during reading of a first sequence of input feature map blocks used to generate partial computations for a first output feature map block, and reading a second time the first input feature map block stored in the input feature map storage during reading of a second sequence of input feature map blocks used to generate a partial computations for a second output feature map block, wherein the first sequence is different from the second sequence. Such examples may allow an increased efficiency in the processing unit because, due to reuse of the first input feature map block, less input feature map data needs to be loaded into the input feature map storage. This reduces the number of operations that need to be performed by the processing unit and thereby reduces power consumption and increases energy efficiency.

Neural networks are typically constructed from three types of layers. An input layer is the initial data for the neural network. An output layer provides the results for given inputs. One or more hidden layers are provided between the input layer and the output layer. The hidden layers may include convolutional layers. Other layers such as pooling layers and deconvolution layers and other structures such as recurrent neural networks may be present. In a convolutional layer, an output data array, referred to as an output feature map (OFM), is computed via convolutions between an input data array, referred to as an input feature map (IFM), and a set of weights.

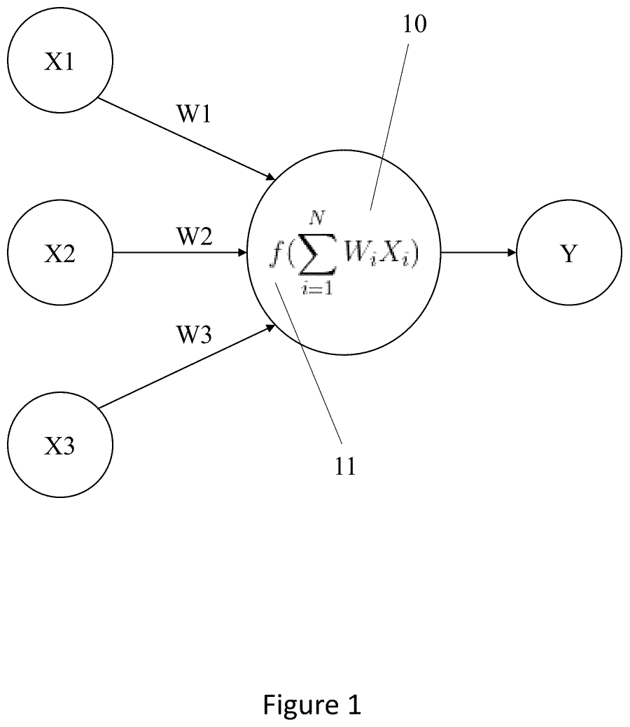

FIG. 1 shows an example of a multiply-accumulate operation 10 performed during calculation of an OFM based on an IFM. The multiply-accumulate operation uses elements from the IFM (X1, X2 and X3), weights (W1, W2 and W3), and an activation function 11 to generate an output element Y. Each IFM element, X1, X2, X3 is multiplied by a corresponding weight W1, W2, W3. The results of the multiplications of the IFM elements with their corresponding weights are added together to generate a multiply-accumulate (MAC) value in step 10. The generation of the sum from the IFM elements and the weights may be referred to as taking a dot product of an IFM vector comprising the IFM elements and a weight vector comprising the corresponding weights. An activation function 11 is applied to the MAC value to generate the output element Y that forms part of the OFM. The activation function 11 may be, for example, a sigmoid function or a hyperbolic tangent function.

There may be more than one OFM element calculated based on a given set of IFM elements from the IFM. In such a case, a dot product between the same IFM elements X1, X2 and X3 and a different set of weights corresponds to a different OFM element. In this way, the weight vectors containing the weights corresponding to a given OFM element may be considered to collectively form a set of weights. The set of weights may therefore have a number of columns equal to the number of OFM elements, and a number of rows equal to the number of IFM elements. The same activation function 11 may be applied to each dot product to generate each output element.

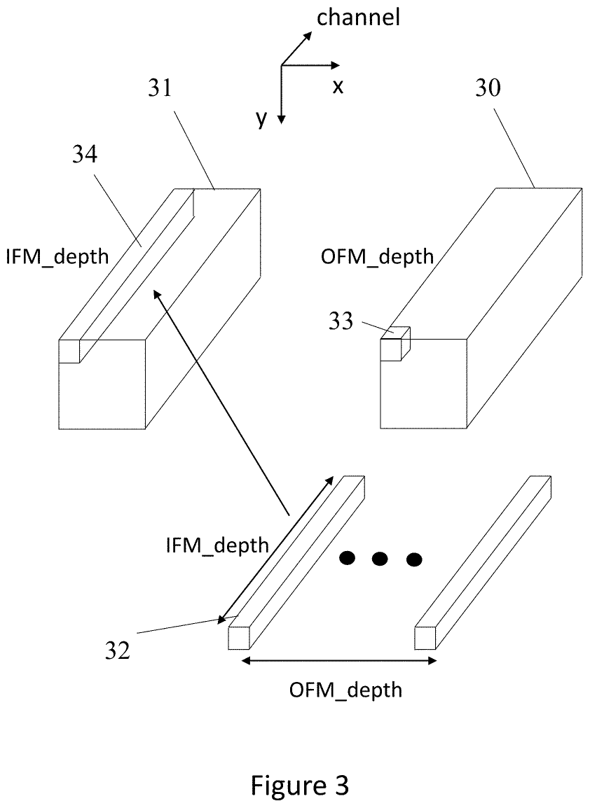

As will be explained in more detail below in connection with FIG. 3, the OFM may not simultaneously use all of the IFM data as inputs to the multiply-accumulate operation. Accordingly, in some examples, the IFM data may be ‘scanned’ by a filter to progressively generate OFM data.

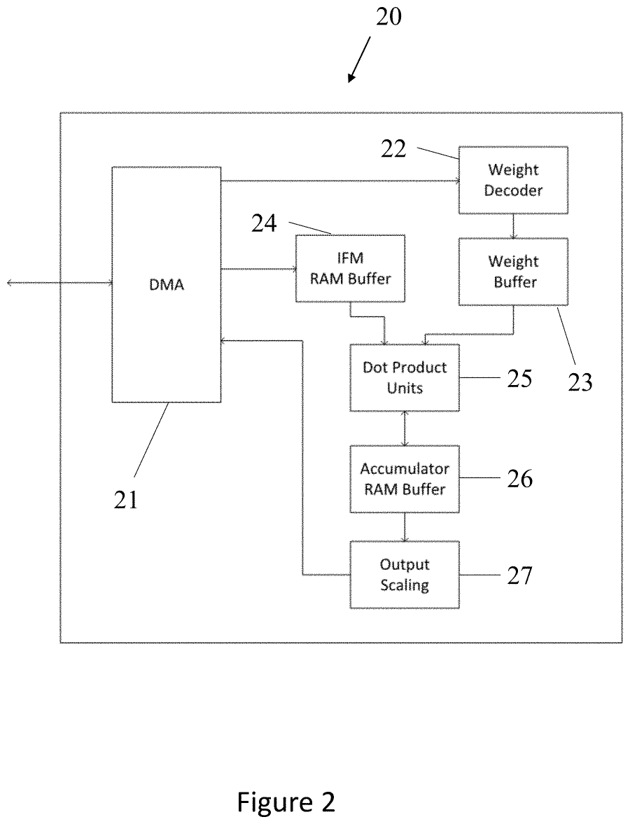

FIG. 2 is a schematic diagram of a neural processing unit (NPU) 20. The NPU 20 is configured to accelerate the performance of calculations associated with neural networks by, amongst other things, efficiently performing multiply-accumulate operations described above in connection with FIG. 1 to generate an OFM.

The NPU 20 comprises a direct memory access (DMA) 21. The DMA is arranged to receive IFM elements and weights from an external storage medium, such as a DRAM, which may not be on the NPU 20. The received IFM elements and weights may have been compressed using a compression scheme. The DMA 21 streams received weight values to a weight decoder 22. The weight decoder 22 reads the weight stream from the DMA 21. The weight decoder 22 decompresses and stores the weight stream in a weight buffer 23.

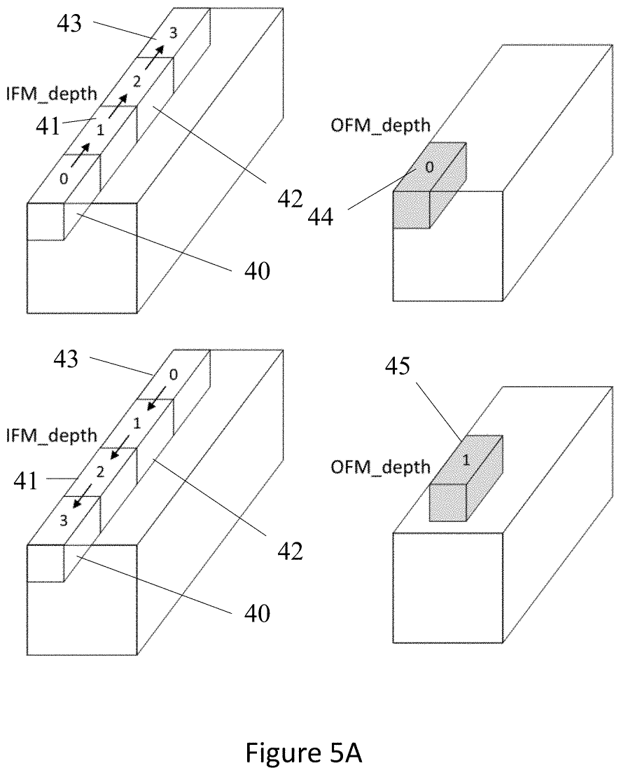

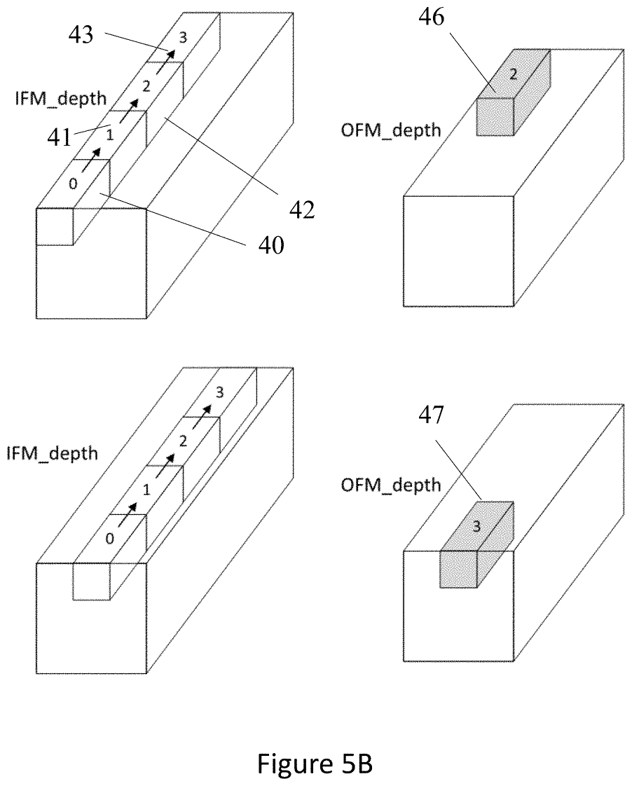

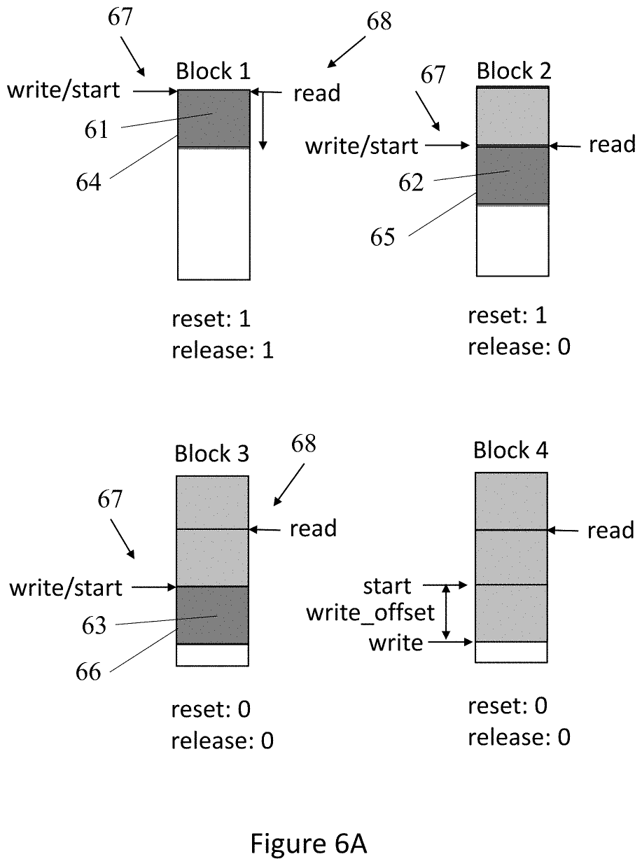

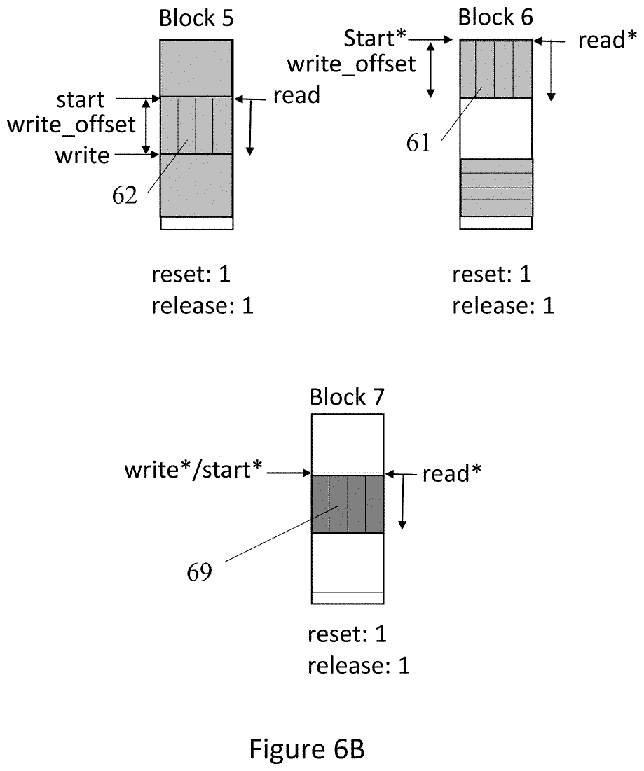

The DMA 21 receives IFM blocks comprising IFM elements from the external storage medium. The DMA 21 transfers the IFM blocks to an input feature map storage in the form of an IFM RAM (Random Access Memory) buffer 24. The IFM RAM buffer 24 sometimes stores multiple IFM blocks simultaneously. The IFM RAM buffer 24 may be controlled so that one or more IFM blocks may be reused without having to be re-transferred from the DMA 21 in certain cases, as described with reference to FIG. 5A. The IFM RAM buffer 24 uses a first-in, first-out (FIFO) register, i.e. the IFM RAM buffer 24 processes the earliest received IFM block first. The processing performed by the IFM RAM buffer 24 is described in more detail in FIG. 6.

IFM blocks in the IFM RAM buffer 24 are read by a plurality of dot product units 25. Weights corresponding to the IFM elements of the IFM block are read from the Weight buffer 23 to be processed by the dot product units 25. Each dot product unit 25 receives an IFM vector of IFM elements and a weight vector of weights corresponding to the IFM elements. Each dot product unit 25 determines a dot product of the IFM vector and the weight vector. Each dot product unit 25 transfers the dot product to an accumulator in an accumulator RAM buffer 26.

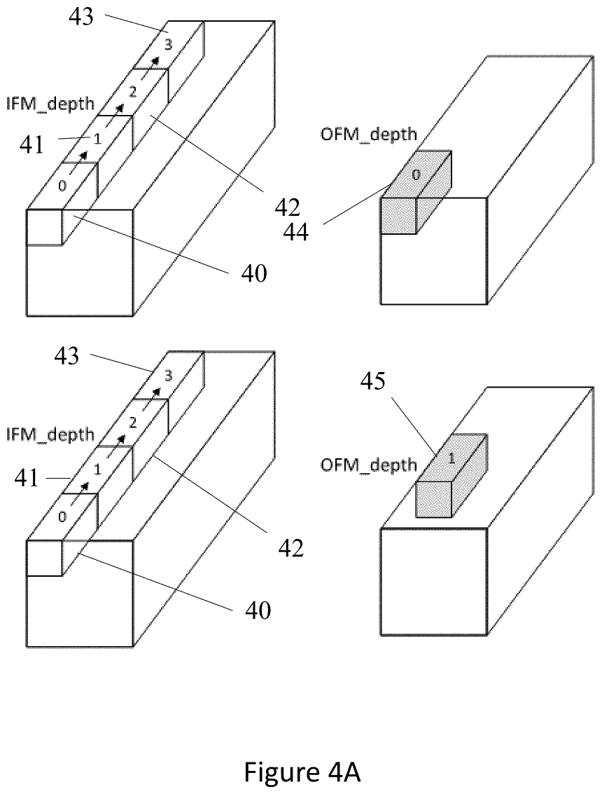

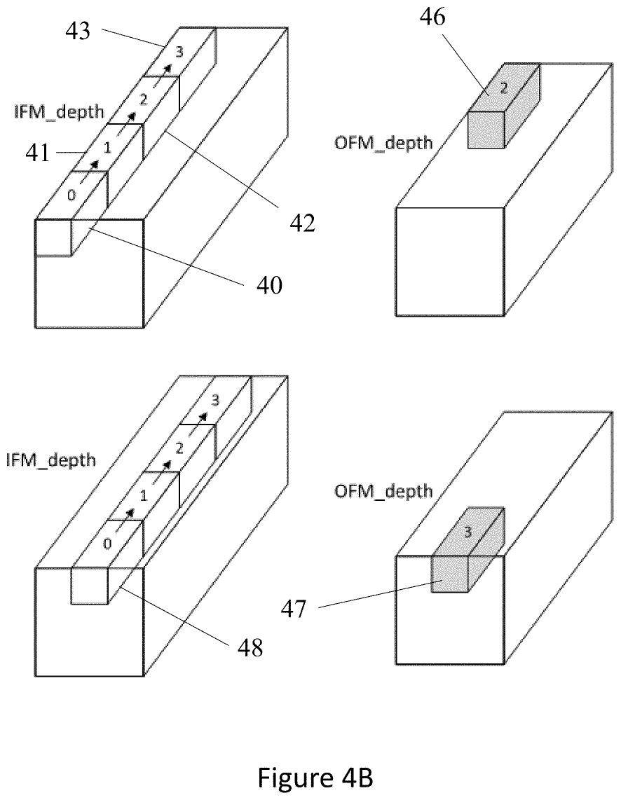

The accumulator RAM buffer 26 comprises a plurality of accumulators. Each accumulator adds together the dot products that it receives from the dot product units 25 to generate a MAC element. Since a dot product of two initial vectors can be decomposed into two or more dot products, each of the two or more dot products generated using pairs of vectors of lower dimension than the two initial vectors, an accumulator can gradually “accumulate” the results of separate dot products taken at different times by the dot product units 25 to generate a MAC element from a weight vector and an IFM vector. In this way, the weight vector and the IFM vector may be broken down into vectors of lower dimension. If the IFM RAM buffer 24 is unable to store an IFM in its entirety, the DMA 21 may group some IFM elements of the IFM into IFM blocks, as will be described with reference to FIG. 4A. In such a case, the accumulator RAM buffer 26 gradually accumulates the results of separate dot products generated using different IFM blocks, in order to generate the MAC element.

Once the accumulator RAM buffer 26 has generated one or more MAC elements, it transfers the MAC elements to an output scaling engine 27. The output scaling engine 27 applies the activation function 11 to each of the MAC elements to generate the output elements of the OFM. The output scaling engine 27 transfers the output elements to the DMA 21. The DMA 21 may transfer the output elements to the external storage medium. Alternatively, the NPU may use the output elements as an IFM to another convolution operation, repeating the convolution operation to generate a second OFM. A different set of weights may be used in the generation of the second OFM.

FIG. 3 shows an example OFM 30 which is computed via a convolution between an IFM 31 and a set of weights 32, the set of weights 32 comprising weight values. The IFM 31 and the OFM 30 are three-dimensional arrays comprising data values. The IFM 31 and the OFM 30 have x, y and channel dimensions, and an element of the IFM 31 or the OFM 30 may be expressed in terms of its x, y and channel coordinates by (x, y, channel). The IFM 31 has a depth IFM depth, i.e. the IFM has a total number of channels equal to IFM depth. Similarly, the OFM 30 has a depth OFM depth. The IFM depth may be different from the OFM depth.

A first OFM element 33 is shown. The first OFM element 33 has coordinates (1, 1, 1), i.e. it is in the first channel of the OFM 30 and has x and y coordinates equal to 1. The first OFM element 33 may be computed by taking the dot product of a first IFM vector 34 comprising all of the elements of the IFM 31 having x and y coordinates equal to 1, with a first row of weights 32 including a vector of weights having a dimension equal to the IFM depth. In order to generate different channels of the OFM having x, y values 1, 1, different rows of weights 32 are sequentially applied to the IFM vector 34. Accordingly, the rows of weights in FIG. 3 are shown as a sequence of rows of weights used to generate the OFM.

Each x, y coordinate uses the same set of weights 32 in this example. Accordingly, the set of weights 32 may be viewed as a filter that is “slided” over the input feature map 31 along the X and Y dimensions to generate the OFM 30.

In general, the OFM 30 and IFM 31 may have different dimensions and the OFM elements 30 may depend on elements of the IFM having different x and y coordinates. In other words, the rows of weights 32 may have a x and y dimensions that are not equal to 1. However, for ease of explanation, in the present example, a filter with a kernel size of 1 is used. This means that the weights do not depend on the x- or y-coordinates of the IFM element. In other words, each value in the OFM 30 at most depends upon the values in a corresponding line of input feature map values 34, which have the same x and y coordinates but varying channel values.

If it were possible to store the first IFM vector 34 in its entirety in the IFM RAM buffer 24, then the first OFM element 33 could be computed with one dot product operation. However, in practice, the IFM RAM buffer 24 may not have sufficient storage space to store the first IFM vector 34. Similarly, the accumulator RAM buffer 26 does not have sufficient storage space to store an OFM vector in its entirety. Therefore, the DMA 21 groups elements of the IFM 31 into smaller IFM blocks for processing by the dot product units 25, and elements of the OFM 30 are grouped into smaller OFM blocks which are stored individually by the accumulator RAM buffer 26, as will be described with reference to FIG. 4A.

The IFM blocks and OFM blocks may be selected to have x and y dimensions greater than 1. The reason for this relates to the re-use of the weight values. As explained above, for a given channel value, the same weights 32 will be used for generating each element having different x, y coordinates in the OFM. Accordingly, if for example the IFM block has x, y dimensions of 2 by 2, when each partial row of weights 32 corresponding to each channel of the IFM block is loaded along with the IFM block, each row of the weights may be used to calculate four elements of the OFM corresponding to the four different x, y coordinates. Accordingly, using an IFM block with a larger x, y dimension is more efficient because it reduces the need to reload weights. However, there is a limit on the number of accumulators in the accumulator RAM buffer 26, which limits the number of OFM elements that may be calculated as IFM blocks are loaded to complete the accumulation along the IFM depth.

FIGS. 4A and 4B show a method for traversing through IFM blocks of the IFM 31 which falls outside of the scope of the claims. As described with reference to FIG. 3, in order to generate a single OFM element, an entire IFM vector (where each element has the same x and y coordinates as the OFM element) must be used. However, since the IFM RAM buffer 24 cannot store each of these IFM elements simultaneously, the IFM 31 may be divided into IFM blocks, such as IFM blocks 40, 41, 42 and 43. As noted above, each IFM block comprises width, height and depth dimensions. In other words, the IFM blocks may comprise multiple IFM elements of a given channel, the multiple IFM elements having different pairs of x and y coordinates. The OFM 30 may also be divided similarly into OFM blocks, such as OFM blocks 44, 45, 46 and 47.

At a first step of the method, a first IFM block 40 is transferred to the IFM RAM buffer 24. A first contribution that is a partial computation for a first OFM block 44 is generated using the first IFM block 40 and partial rows of weights corresponding to the channels included in the first OFM block 44. In the present example where the kernel size is 1, the first IFM block 40 and the first OFM block 44 have the same width dimensions, and the same height dimensions. The first IFM block and the first OFM block 44 span the domains 1≤x≤N and 1≤y≤M. The first IFM block 40 has a number of channels equal to the depth of the first IFM block 40, and the first OFM block 44 has a number of channels equal to the depth of the first OFM block 44. The number of partial rows of weights 32 used is equal to the depth of the first OFM block 44, and a number of entries forming each partial row of weights is equal to the depth of the first IFM block 40. The quantity of weights is independent of the height, y, and width, x, of the first IFM block 40 and the first OFM block 44. Therefore, reducing the depth of the first IFM block 40 while expanding its domains in the x and y dimensions, in such a way to keep the total number of elements of the first IFM block constant, reduces the size of the partial rows of weights.

The first contribution, from the first IFM block 40, for the first OFM block 44 is an array of data values with dimensions equal to the dimensions of the first OFM block 44. Each element of the first contribution having coordinates (x₁, y₁, c₁) is generated by taking the dot product of a partial IFM vector with weights from the row of weights associated with c₁. The partial IFM vector comprises the IFM elements in the first IFM block 40 which have x-coordinate equal to x₁ and y-coordinate equal to y₁.

At a second step, a second IFM block 41 is transferred to the IFM RAM buffer 24. A second contribution for the first OFM block 44 is generated using the second IFM block 41 and different weight values from the same rows of weights used for the first IFM block 40. The OFM block 44 being calculated hasn't changed so the same rows of weights corresponding to channels of the OFM block 44 are used. However, different entries within the rows of weights are used corresponding to the different IFM channels read from the buffer associated with second IFM block 41. The second IFM block 41 spans the same domains as the first channel, i.e. 1≤x≤N and 1≤y≤M. The second contribution for the OFM is generated in the same way as the first contribution, and is added to the values accumulated in the accumulator RAM Buffer for the first OFM block 44.

This process is repeated to generate third and fourth contributions for the first OFM block 44 using the third 42 and fourth 43 IFM blocks respectively. The first IFM block 40, second IFM block 41, third IFM block 42 and fourth IFM block 43 collectively comprise IFM elements for every channel of the IFM 31. It will be appreciated that the number of IFM blocks may be different from the four shown in FIG. 4A, and that the method of FIG. 4A shows four IFM blocks purely for illustrative purposes.

In this way, the OFM block for which contributions are to be generated is fixed at the first OFM block 44, while the IFM blocks 40, 41, 42, and 43 are traversed in a first order. The first, second, third and fourth contributions are added together in the accumulator RAM buffer 26, as described with reference to FIGS. 2 and 3, to generate the first OFM block 44 after scaling by the output Scaling engine 27.

Once the first OFM block 44 has been generated, the accumulator RAM buffer 26 may be free to store accumulators for a second OFM block 45. The second OFM block 45 comprises a set of channels different from the channels of the first OFM block 44. The second OFM block 45 spans the same domains as the first OFM block 44, i.e. 1≤x≤N and 1≤y≤M. Accordingly, a second set of rows of weights 32 corresponding to channels included in the second OFM block 45 are used for calculating the second OFM block 45. The same process described above for calculating the first OFM block is used as depicted in the lower part of FIG. 4A, whereby four IFM blocks are sequentially processed and the contributions gathered in the accumulator RAM buffer 26 to generate the second OFM block 45.

In the present example which falls outside of the scope of the claims, the IFM blocks 40, 41, 42 and 43 are traversed in the same first order as for the first OFM block 44, to generate contributions for the second OFM block 45. In this way, each IFM block must be transferred to the IFM RAM buffer 24 each time it is used to generate a contribution for an OFM block.

FIG. 4B shows a continuation of the method shown in FIG. 4A. The IFM blocks are traversed in the same first order when generating contributions for a third OFM block 46. The third OFM block 46 comprises a set of channels different from the channels of the first OFM block 44 and second OFM block 45. Accordingly, the third OFM block 46 is generated using different rows of weights 32 corresponding to the channels in the third OFM block 46. The third OFM block 46 spans the same domains as the first OFM block 44, i.e. 1≤x≤N and 1≤y≤M. The first 44, second and third 46 OFM blocks collectively comprise OFM elements for every channel of the OFM 30. It will be appreciated that the number of OFM blocks may be different from the three shown in FIGS. 4A and 4B, and that the method of FIGS. 4A and 4B shows three OFM blocks purely for illustrative purposes.

A fourth OFM block 47 receives contributions from a different set of IFM blocks to those which are used to generate contributions for the first OFM block 44, second OFM block 45 and third 46 OFM block. The fourth OFM block 47 has the same channels as the first OFM block 44, but spans the domains N+1≤x≤P and 1≤y≤M. A fifth IFM block 48 spans the same domains as the fourth OFM block 47 and comprises the same channels as the first IFM block 40. The procedure for generating contributions for the fourth OFM block 47 may proceed similarly as for the first OFM block 44, using the appropriate IFM blocks. The same weights are streamed to the weight decoder 22 for the fourth OFM block 47 as for the first OFM block 44.

By continuing to generate the OFM blocks in this way, the complete OFM 30 may be generated by sliding the filters 32 across the x and y dimensions in row major order.

FIGS. 5A and 5B show a method for iterating through IFM blocks of the IFM 31 in accordance with an embodiment. The first OFM block 44 is generated as described in FIG. 4A. For the second OFM block 45, the order in which the IFM blocks 40, 41, 42 and 43 are traversed is reversed. When generating the first OFM block and second OFM block 45, the IFM blocks are loaded into the IFM RAM buffer 24 in the order first IFM block 40, second IFM block 41, third IFM block 42, fourth IFM block 43, fourth IFM block 43, third IFM block 42, second IFM block 41, first IFM block 40. Thus, for example, the fourth IFM block 43 is used twice consecutively. The IFM RAM buffer 24 may hold IFM blocks, so that IFM blocks may be reused without IFM block data having to be re-transferred from the DMA 21. In the case of the method described by FIGS. 5A and 5B, this means that, for example, the fourth IFM block 43 may be used twice consecutively, firstly to generate a contribution for the first OFM block 44, and secondly to generate a contribution for the second OFM block 45, without having to be re-transferred from the DMA 21 between generating these two contributions, as would be the case in the method described by FIGS. 4A and 4B. This reuse of IFM data in the IFM RAM data buffer 24 reduces the number of memory transfers which must be performed by the NPU 20, thus reducing the power consumption and heat generated by the NPU 20.

As shown by FIG. 5B, the reversal of the order of traversal of the IFM blocks may be repeated for each OFM block. As the sequence of IFM blocks for calculating the second OFM block 45 ends and the sequence of IFM blocks for calculating the third OFM block 46 begins, the IFM blocks stored in the IFM RAM buffer 24 may again be reused. When generating the second OFM block 45 and third OFM block 46, the IFM blocks are loaded into the IFM RAM buffer 24 in the order fourth IFM block 43, third IFM block 42, second IFM block 41, first IFM block 40, first IFM block 40, second IFM block 41, third IFM block 42, fourth IFM block 43. Thus, for example, the first IFM block 40 is used twice consecutively. The IFM RAM buffer 24 may hold IFM blocks, so that IFM blocks may be reused without IFM block data having to be re-transferred from the DMA 21. Accordingly, reuse of the data may occur at either end of the sequence and reversed sequence when generating OFM blocks having the same x, y domain.

Looking at the bottom of FIG. 5B, the fourth OFM block 47 that is the first of the next x, y domain (position of the filter) is shown. No reuse of IFM block data is possible when moving from the calculations for the third OFM block 46 to calculations for the fourth OFM block 47, which is the first IFM block of the next x, y domain, because the IFM block data needed for the calculations is different.

Reversing the order of traversal as described above requires making a simple change to the order in which the weights are streamed to the weight decoder 22 so that the appropriate weights are available for processing of each IFM block. The weights of a neural network are known in advance of processing and the order of the weights may be adjusted by a compilation process prior to processing by the NPU 20 so that the weight values may be streamed in a correct order.

As will be described with reference to FIG. 6, the IFM RAM buffer 24 may store multiple IFM blocks, meaning that multiple IFM blocks may be reused in this way. It will be appreciated that the examples shown in FIGS. 4A, 4B, 5A and 5B having four IFM blocks which comprise IFM elements for every channel of the IFM 31 is purely for illustrative purposes, and that the number of IFM blocks traversed for a single OFM block may be different from, and potentially much larger than, four. The number of IFM blocks traversed for a single OFM block may be greater than five.

FIGS. 6A and 6B show an example method performed by an IFM RAM buffer 24 under control of a central controller (not shown) for reversing the order in which IFM blocks are processed. The IFM RAM buffer 24 is controlled as a circular, first-in first-out (FIFO) buffer. In the example method of FIG. 6, the IFM RAM buffer may store up to three IFM blocks simultaneously. Similar to the method described above in connection with FIGS. 5A and 5B, three IFM blocks at the end of the traversal sequence of an OFM block are processed in a first order by the dot product units 25, and then the order is reversed so that the IFM blocks are processed in the reverse order by the dot product units 25 at the start of the traversal sequence of the next OFM block. The method performed by the IFM RAM buffer 24 as shown by FIGS. 6A and 6B is appropriate when the number of IFM blocks to be traversed per OFM block is greater than five.

The IFM RAM buffer 24 is operated through signalling. The IFM RAM buffer 24 is controlled by an input block start address pointer 67 (hereinafter referred to as “start pointer”), an input block read pointer 68 (hereinafter referred to as “read pointer”), an input block write pointer (hereinafter referred to as “write pointer”), an input block release signal (hereinafter referred to as “release signal”), and an input block reset signal (hereinafter referred to as “reset signal”).

Reading of IFM blocks from the IFM RAM buffer 24 is controlled by the start pointer which provides an address from which reading should commence.

The IFM RAM buffer 24 is managed so that the data is written at the write pointer and data that has been read is indicated by the read pointer. The write pointer is controlled not to write data beyond the read pointer. Accordingly, movement of the read pointer releases data. The release signal being set to 1 indicates that data is released and the read pointer is moved, whereas the release signal being set to 0 indicates that data is not released and the read pointer is not moved.

The description of FIGS. 6A and 6B picks up part way through processing of a row of IFM blocks in the channel dimension. FIGS. 6A and 6B illustrate processing of the last three IFM blocks for an OFM block and the processing of the first three IFM blocks in the reverse order for the next OFM block representing the same domain in the x, y dimensions but different OFM channels. Accordingly, the method begins at Block 1 with the processing of a first IFM block 61. The first IFM block 61 is the third-last in the traversal sequence of a first OFM block. The reset signal is set to 1. This means that the read pointer 68 is moved to the same address position as the start pointer 67 prior to the processing of the first IFM block 61. The write pointer address is read and the first IFM block 61 is written to a first region 64 of the IFM RAM buffer 24. The start pointer 67 address is read and data of the first IFM block Elis read by the dot product units 25. As a result, the write pointer and the start pointer 67 move from a first address position shown schematically in connection with Block 1 to a second address position shown schematically in Block 2 of the IFM RAM buffer 24 in FIG. 6A. At this time, the release signal is set to 1. This means that the read pointer address 68 moves with the start pointer address 67 to the end of the first IFM block 61, releasing the first IFM block 61, so that it can be rewritten as the first block of data is read. The first IFM block 61 is not yet erased from the IFM RAM buffer 24.

The method continues at Block 2 with the processing of a second IFM block 62. The second IFM block 62 is the second-last in the traversal sequence of the first OFM block. The reset signal is still 1. This means that the read pointer 68 is moved to the same address position as the start pointer 67 prior to processing of the second IFM block 62. The write pointer writes the second IFM block 62 to the second region of the IFM RAM buffer 24. The address of the start pointer 67 is read and the second IFM block 62 is read to the dot product units 25. The release signal is set to 0, so the read pointer stays at the end of the first block. The second IFM block 62 is therefore not released and cannot be overwritten yet.

Block 3 illustrates processing of a third IFM block 63 that is the last in the traversal sequence of IFM blocks for the first OFM block. The reset signal is set to 0. This means that the read pointer 68 does not move to the position of the start pointer prior to processing of the third IFM block 63. The write pointer is read and the third IFM block 63 is written to a third region 66 of the IFM RAM buffer 24. The address pointer 67 is read and the third IFM block 63 is transferred to the dot product units 25. The release signal is still 0, so the read pointer stays at the end of the first IFM block 61. The second 62 and third 63 IFM blocks are therefore not released.

Once the third IFM block 63 has been transferred to the dot product units a first time, the traversal of the IFM blocks for the first OFM block is completed. The order of transferring the IFM blocks to the dot product units 25 is reversed. The reset signal is still 0, which means that the read pointer 68 does not move to the address position of the start pointer 67 prior to the second processing of the third IFM block 63.

At Block 4, the start pointer 67 is read and the third IFM block 63 is transferred a second time to the dot product units 25. Note that the data of the third IFM block 63 is reused and the data is not written again to the IFM RAM buffer 24. The write pointer is set by the central controller to be offset from the start pointer 67 by the size of the third IFM block 63, as shown in Block 4. Because the write pointer is positioned at the end of the buffer holding the third IFM block 63, the DMA 21 is instructed that no new data needs to be written The third IFM block 63 cannot be released yet, because releasing the third IFM block 63 would also cause the second IFM block 62 to be released, but the second IFM block 62 has not yet been re-transferred to the dot product units 25. Therefore, the release signal is still 0, and the read pointer stays at the end of the first IFM block 61.

At Block 5, the reset signal is set to 1. The read pointer stays at the end of the first IFM block 61. The start pointer 67 address is moved to the start of the second IFM block 62 and the second IFM block 62 is transferred a second time to the dot product units 25. Again, the data of the second IFM block 62 is re-used and the data is not written again. The write pointer is again offset from the start pointer 67 by one IFM block, as shown in Block 5. The release signal is changed to be set to 1, so the read pointer 68 moves with the start pointer 67 to an address at the end of the second IFM block 62. The second IFM block 62 is released. The second IFM block 62 is effectively erased from the IFM RAM buffer 24.

At Block 6, the reset signal is still 1, so the read pointer 68 moves from the third position to the start of the first IFM block 61 along with the start pointer 67. The IFM RAM buffer 24 is a circular buffer, so the read pointer 68 moves across the third IFM block 63 to reach the start of the first IFM block 61. The third IFM block 63 is consequently released. The third IFM block 63 is effectively erased from the IFM RAM buffer 24. The start pointer 67 address is read and the first IFM block 61 is transferred a second time to the dot product units 25. Again the first IFM block 61 is re-used and is not re-written to the IFM RAM buffer 24. The write pointer is again offset from the address pointer 67 by the size of the first IFM block 61, as shown in Block 6. The offset of the write pointer signals that data does not need to be written to the IFM RAM buffer 24. The release signal is still 1, so the read pointer 68 moves with the start pointer 67 to the end of the first IFM block.

This completes the reversal of the order in which IFM blocks are traversed. From Block 7 onwards until and including the fourth-last IFM block in the traversal sequence for the second OFM block, the IFM blocks are sequentially written to the IFM RAM buffer 24 and transferred to the dot product units 25. The write pointer and start pointer 67 stay one block ahead of the read pointer 68. The read pointer 68 continuously releases the previously transferred IFM block.

At Block 7, the start pointer 67 is at the address at the end of the first IFM block 61. The reset signal is still 1, so the read pointer 68 moves to the end of the first IFM block 61. The write pointer writes a fourth IFM block 69 to the second region of the IFM RAM buffer 24. The start pointer 67 address is read and the fourth IFM block 69 is transferred to the dot product units 25. The release signal is still 1, so the read pointer 68 moves with the start pointer 67 to the end of the fourth IFM block 69. The fourth IFM block 69 is consequently released. The fourth IFM block 69 is effectively erased from the IFM RAM buffer 24.

Subsequent IFM blocks up to and including the fourth-last IFM block in the traversal sequence of the second OFM block are processed with the same signalling as that described in relation to Block 7. The only difference is that the start, write and read pointers move by one position per IFM block.

An extra detail of the method just described in connection with FIGS. 6A and 6B relates to a wrap parity bit. The wrap parity bit is an extra bit added to the read pointer and write pointer addresses. The wrap parity bit is used to see if the IFM RAM buffer 24, which operates as a FIFO, is empty or full using the read and write pointers. If IFM RAM buffer 24 contains 256 positions, each of the read pointer address and write pointer address can be written in 8 bits (corresponding to 256 values) and the extra parity bit keeps track of whether the pointer has wrapped around an odd or even number of times. If the IFM RAM buffer 24 is full the start pointer address is 0 and write start address is 0 representing the start of the buffer. Similarly, if the IFM RAM buffer 24 is empty the read pointer start address would be 0 and the write pointer address would be 0. Accordingly, it is not possible to determine if the IFM RAM buffer 24 is full or empty based on the start pointer and write pointer addresses alone. Because the two addresses include an extra parity bit, it becomes possible to determine whether the buffer is full (the parity bits are different between the read address and the write address) or empty (the parity bits are the same between the read address and the write address).

At the start of Block 6 above, the parity bits on the write pointer and read pointer 68 are each swapped (because effectively the write pointer and the read pointer have each done a full loop). The swapped parity bits are illustrated with an ‘*’.

At the start of the 7th block the read pointer 68 and the write pointer each have swapped parity bits. For the case when the write pointer is positioned at the end of the first IFM block 61, as shown in Block 7, ready to write the fourth IFM block 69, but the read pointer 68 is positioned as shown in Blocks 2 to 5 where it is not finished with the existing data, the read pointer 68 and write pointer have the same address but different parity, which indicates that the IFM RAM buffer 24 is full. Until the read pointer 68 starts reading at Block 5 the write pointer stalls and no data is written. When both the write pointer and read pointer are on Block 7, they now have the same address with the same parity bit indicating that the buffer is empty, which is correct because all the reused blocks have been read. As described above, the write offset is set to 0 and the process is conceptually the same as the first IFM block but starting from the address position at the end of the first IFM block 61.

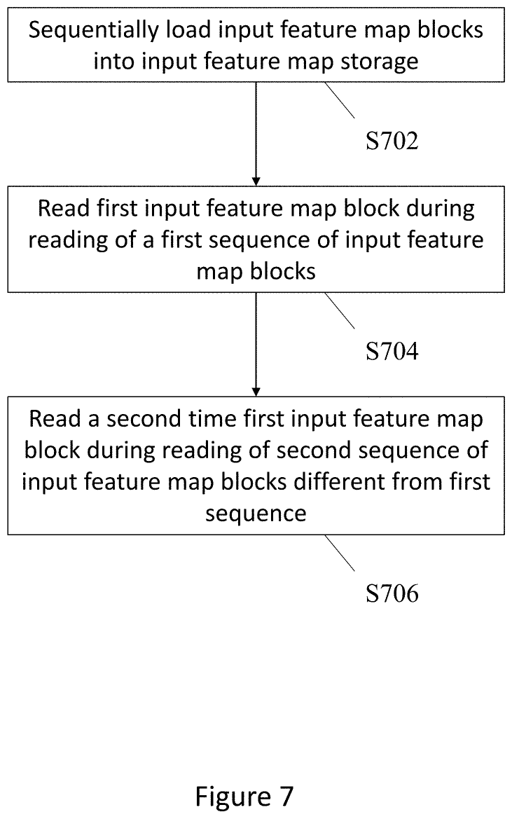

FIG. 7 is a flow chart showing an example method performed by a processing unit, such as an NPU 20, according to previously described embodiments. The method results in the generation of at least part of an output feature map 30. As described above, the processing unit 20 comprises an input feature map storage in the form of IFM RAM buffer 24 configured to store input feature map blocks. The IFM RAM buffer 24 can store a predetermined number of input feature map blocks. The input feature map blocks are readable by the processing unit 20 to generate output feature map blocks.

The processing unit 20 may transfer the input feature map blocks from the input feature map storage to dot product units 25. The dot product units 25 may process the input feature map blocks for generating output feature map blocks. The input feature map blocks may each comprise at least one input feature map channel. The output feature map blocks may each comprise at least one output feature map channel. A set of weights 32 used by the dot product units 25 may comprise rows of weights, each row of weights corresponding to an output feature map channel and weight values in each row of weights corresponding to the input feature map channels.

In a first step S702, the processing unit 20 sequentially loads input feature map blocks into the input feature map storage. The input feature map blocks stored in the input feature map storage at a given time during the sequential loading form a subset of a plurality of input feature map blocks that are required to generate each output feature map block. The input feature map storage may be controlled to operate as a first-in first-out buffer. The input feature map blocks may be transferred from an external storage that is external to the processing unit 20 to the input feature map storage.

In a second step S704, the processing unit 20 reads a first input feature map block 43 stored in the input feature map storage. This step occurs during reading of a first sequence of input feature map blocks used to generate partial computations for a first output feature map block 44. Step S704 may comprise generating a partial computation for a given output feature map block by calculating, by the dot product units 25, for each output feature map channel of the given output feature map block, a dot product between a partial row of weights corresponding to each output feature map channel and an input feature map vector. The input feature map vector may comprise the input feature map elements for each input feature map channel of the given input feature map block. Generating the given output feature map block may comprise, for each output feature map channel of the given output feature map block, summing the dot products generated for the output feature map channel.

In a third step S706, the processing unit 20 reads for a second time the first input feature map block 43 stored in the input feature map storage. This step occurs during reading of a second sequence of input feature map blocks used to generate partial computations for a second output feature map block 45. The second sequence is different from the first sequence. The first sequence may be a linear sequence of input feature map blocks in a first direction along a channel dimension of the input feature map 31. The second sequence may be the reverse of the first sequence. The first input feature map block 43 may be a final input feature map block of the first sequence. The first input feature map block 43 may be a first input feature map block of the second sequence.

During the method for generating an output feature map, the processing unit 20 may control an address pointer 67 of the input feature map storage to control the sequence in which input feature map blocks are used to generate partial computations for the second output feature map block 45. The processing unit 20 may control a read pointer 68 and a release signal to release input feature map blocks. The read pointer 68 and release signal may be controlled so that the first input feature map block 43 can be reused. The processing unit 20 may control a write pointer to control writing of input feature map blocks to the input feature map storage. The read pointer 68, release signal and write pointer may be controlled to prevent writing over the first input feature map block 43 in the input feature map storage until it has been reused to generate a partial computation for the second output feature map block 45.

The above embodiments are to be understood as illustrative examples. Further embodiments are envisaged. For example, the example of FIGS. 6A and 6B above re-uses three IFM blocks. However, the IFM block size may vary depending on several factors including filter size (x, y dimensions of the filters). Accordingly, it may be possible to fit different numbers of IFM blocks in the IFM RAM buffer 24 and, accordingly, to reuse different numbers of IFM blocks. The NPU 20 may be configured to control the reuse of a maximum number of IFM blocks. In some implementations the maximum number of IFM blocks that may be reused may be four.

In some implementations, one or more stored IFM blocks may be reused for the duration of calculating the sequence of OFM blocks for a particular domain. In one example the number of IFM blocks required to generate an OFM block may be five, and the number of IFM blocks which can be stored in the IFM RAM buffer 24 at a given time may be three. In such a case, the third IFM block of the sequence of five IFM blocks may continuously be stored in the IFM RAM buffer 24 during the generation of a plurality of OFM blocks for the domain corresponding to the IFM blocks without being overwritten.

Examples above use an NPU 20 to accelerate the processing of machine learning models. However, it is envisaged that the techniques described above could be applied to other types of processing unit, such as central processing units (CPU) and graphics processing units (GPU).

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A method performed by a processing unit for generating an output feature map, the processing unit comprising an input feature map storage configured to store input feature map blocks, the input feature map storage being readable by the processing unit to generate output feature map blocks, the method comprising:
sequentially loading input feature map blocks into the input feature map storage, wherein the input feature map blocks stored in the input feature map storage at a given time during the sequential loading form a subset of a plurality of input feature map blocks that are required to generate each output feature map block;
reading a first input feature map block stored in the input feature map storage during reading of a first sequence of input feature map blocks used to generate partial computations for a first output feature map block; and
reading a second time the first input feature map block stored in the input feature map storage during reading of a second sequence of input feature map blocks used to generate partial computations for a second output feature map block, wherein the first sequence is different from the second sequence.

2. The method according to claim 1, wherein the first input feature map block is a final input feature map block of the first sequence, and the first input feature map block is a first input feature map block of the second sequence.

3. The method according to claim 1, wherein the first sequence is a linear sequence of input feature map blocks in a first direction along a channel dimension of the input feature map.

4. The method according to claim 3, wherein the second sequence is the reverse of the first sequence.

5. The method according to claim 1, wherein the processing unit transfers the input feature map blocks from the input feature map storage to dot product units, and the dot product units process the input feature map blocks for generating the output feature map blocks.

6. The method according to claim 5, wherein:
the input feature map blocks each comprise at least one input feature map channel, the output feature map blocks each comprise at least one output feature map channel, a set of weights comprises rows of weights, each row of weights corresponding to an output feature map channel and weight values in each row of weights corresponding to the input feature map channels, and the method comprises:
generating a partial computation for a given output feature map block using a given input feature map block by calculating, by the dot product units, for each output feature map channel of the given output feature map block, a dot product between a partial row of weights corresponding to each output feature map channel and an input feature map vector, the input feature map vector comprising the input feature map elements for each input feature map channel of the given input feature map block; and
generating the given output feature map block comprises, for each output feature map channel of the given output feature map block, summing the dot products generated for the output feature map channel.

7. The method according to claim 1, wherein the input feature map storage is able to store a predetermined number of input feature map blocks.

8. The method according to claim 7, wherein the method comprises reusing the predetermined number of input feature map blocks without reloading the predetermined number of input feature map blocks into the input feature map storage to generate partial computations for the second output feature map block.

9. The method according to claim 1, wherein the input feature map storage is controlled to operate as a first-in first-out buffer.

10. The method according to claim 9, wherein:
the first input feature map block is both a final input feature map block of the first sequence and a first input feature map block of the second sequence, and
the processing unit controls an address pointer of the input feature map storage to control the sequence in which input feature map blocks are used to generate partial computations for the second output feature map block.

11. The method according to claim 1, wherein the processing unit controls a read pointer and a release signal to release input feature map blocks and the read pointer and release signal are controlled so that the first input feature map block can be reused.

12. The method according to claim 11, wherein the processing controls a write pointer to control writing of input feature map blocks to the input feature map storage and the read pointer, release signal and write pointer are controlled to prevent writing over the first input feature map block in the input feature map storage until it has been reused to generate a partial computation for the second output feature map block.

13. A method according to claim 1, wherein sequentially loading the input feature map blocks into the input feature map storage comprises transferring the input feature map blocks from an external storage that is external to the processing unit to the input feature map storage.

14. A processing unit configured to perform a method for generating an output feature map, the processing unit comprising an input feature map storage configured to store input feature map blocks, the input feature map storage being readable by the processing unit to generate output feature map blocks, the method comprising:
sequentially loading input feature map blocks into the input feature map storage, wherein the input feature map blocks stored in the input feature map storage at a given time during the sequential loading form a subset of a plurality of input feature map blocks that are required to generate each output feature map block;
reading a first input feature map block stored in the input feature map storage during reading of a first sequence of input feature map blocks used to generate partial computations for a first output feature map block; and
reading a second time the first input feature map block stored in the input feature map storage during reading of a second sequence of input feature map blocks used to generate partial computations for a second output feature map block, wherein the first sequence is different from the second sequence.

15. A computer-readable medium storing instructions which, when executed by a processing unit, cause the processing unit to perform:
a method performed by the processing unit for generating an output feature map, the processing unit comprising an input feature map storage configured to store input feature map blocks, the input feature map storage being readable by the processing unit to generate output feature map blocks, the method comprising:
sequentially loading input feature map blocks into the input feature map storage, wherein the input feature map blocks stored in the input feature map storage at a given time during the sequential loading form a subset of a plurality of input feature map blocks that are required to generate each output feature map block;
reading a first input feature map block stored in the input feature map storage during reading of a first sequence of input feature map blocks used to generate partial computations for a first output feature map block; and
reading a second time the first input feature map block stored in the input feature map storage during reading of a second sequence of input feature map blocks used to generate partial computations for a second output feature map block, wherein the first sequence is different from the second sequence.
